(19) United States
(12) Patent Application Publication
(10) Pub. No.: US 2003/0024940 A1
(43) Pub. Date: Feb. 6, 2003

(54) Candy racer

(76) Inventors: Thomas J. Coleman, Abingdon, VA (US); William K. Schlotter IV, Fredericksburg, VA (US); Princess Ann Coleman, Abingdon, VA (US); Ann M. Schlotter, Fredericksburg, VA (US)

Correspondence Address: Melvin L. Crane, 318 South Cleveland Street, Arlington, VA, 22204-2038, US

(21) Appl. No.: 09/920,277

(22) Filed: Aug. 2, 2001

(51) Int. Cl. G07F 11/00

(52) U.S. Cl. 221/24

(57) ABSTRACT

A candy racer designed so that a child or any other person can observe one or more pieces of candy racing along a track within a housing. A race track is provided within the housing so that the candy pieces pass from one part of the track to another part in succession until the candy piece or pieces reach a reservoir. Axially aligned housings joined to each other may be used for forming a longer race track. The candy racer could be used as a game by at least two players to see which racing piece reaches the bottom first. The race track may be reversed for racing back to the start receptacle.

### BACKGROUND OF THE INVENTION

This invention is an improvement over U.S. Pat. No. 6,234,344 issued May 22, 2001, to applicants.

This invention is directed to a candy racer and more particularly to a candy racer device which includes a housing with ends that can be connected to each other to provide a longer racer track in which candy pieces placed into a chamber of a first racer track can race down two or more racer housings connected together. A cover can be secured to an open end of each of the racers which will prevent the candy pieces from dropping from the end after the candy has raced along the length of one or more racer housings.

Heretofore, devices have been patented by which objects can travel from an upper end to a lower end so that the objects can be seen as they travel from the upper end to the lower end. These devices also have a reservoir or receptacle at the bottom end which receives the candy pieces for dispensing to a user. Such prior art is restricted to a one-way travel for the pieces.

This invention has interconnecting housings so that the candy can travel a greater distance. Once the candy pieces have reached the bottom, the connected housing can be turned upside-down and the candy pieces can race along the length of two or more housings. It is obvious that the housings can be made of any suitable length so that two or more housings can be connected together.

### OBJECTS AND ADVANTAGES

It is therefore an object of the invention to provide a candy racer dispensing device by which a piece of candy or any other desired piece of a product can race from one end to the other having at least two connectable housing pieces. The candy pieces can race first in one direction. Then the housings can be turned 180 degrees so that the candy can race back to the starting end.

Another object is to provide a candy dispensing device which permits candy pieces to traverse either direction of the device.

Another object is to provide a device which has no distinguishable top or bottom.

Yet another object is to provide a device in which either end becomes the top or bottom depending on the manner in which the device is held vertically.

Another object is to provide a candy toy device which can be enjoyed by one or more persons who can place a same number of like pieces of candy in one end and race the pieces of candy in one or both directions to see whose candy pieces are the winner.

Other objects and advantages of the invention will be obvious to those skilled in the art upon a review of the specification, claims and drawings.

### BRIEF DESCRIPTION OF THE DRAWINGS

FIG. 1 illustrates a racer with two separate aligned housings, each of which can be interconnected to each other and including a spiral candy track;

FIG. 2 illustrates a racer with two separate aligned housings, each of which can be interconnected to each other and each of the housings having spaced parallel candy tracks which are perpendicular to an axis of the housing;

FIG. 3 illustrates a racer track with two separate aligned interconnecting housings in which one housing has a spiral racer track such as set forth in FIG. 1, and the other racer track housing includes a racer track as set forth in FIG. 2; and

FIG. 4 illustrates a racer track with two separate housings in which one housing includes axially aligned parallel cross pieces, each of which have an aperture through which pieces of candy can pass and the other housing has a spiral racer track such as shown in FIG. 1.

### DESCRIPTION OF THE PREFERRED EMBODIMENT

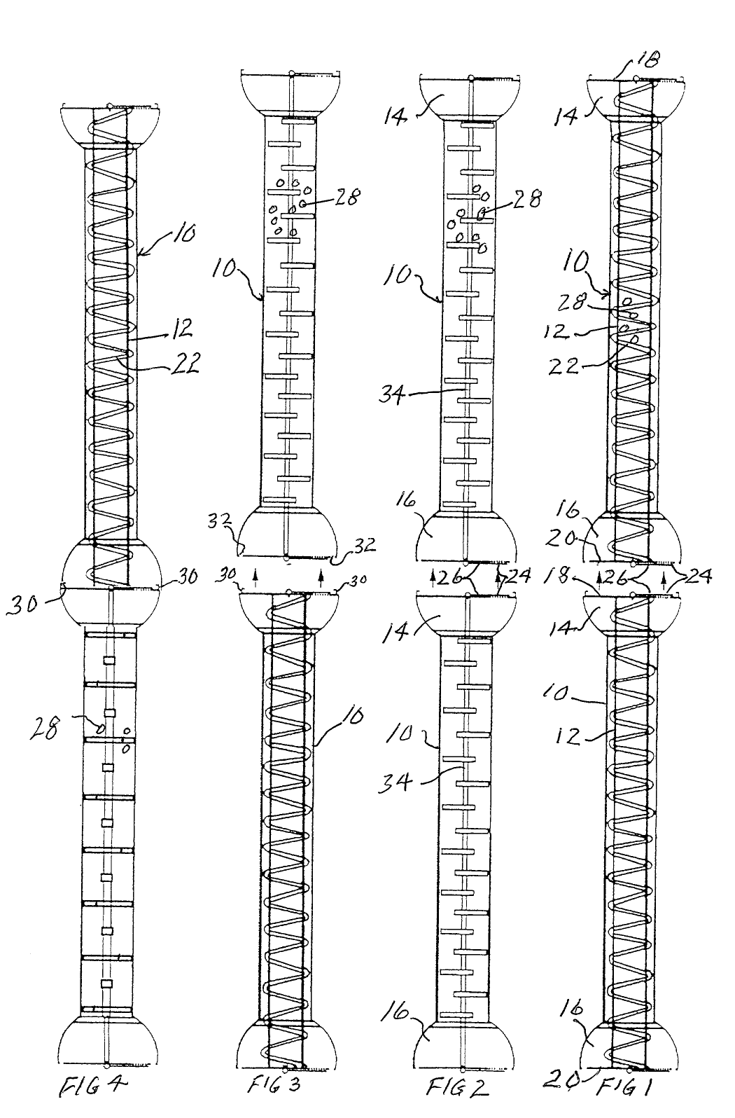

Now referring to the drawings, in which the same reference characters represent the same parts throughout the different views, FIG. 1 illustrates a two-piece cylindrical, axially aligned housing 10 made of plastic through which the inner parts can be seen. An inner cylindrical housing 12 extends coaxially beyond each end of the housing 10 and into a semi-cylindrical reservoir 14, 16 which is secured to the ends of the outer housing, or may be made as an integral part of the outer housing.

The inner housing is secured in place by end caps 18 and 20 which are on an end surface of each of the reservoirs. Within the main housing and between the inner surface of the main housing and the outer surface of the inner housing, a spiral candy track 22 surrounds the inner housing and extends from an upper end of the inner housing within the reservoir 14 down to the lower end of the outer housing and within the lower reservoir 16. The spacing between the outer housing and the inner housing must be a radial distance which is greater than a diameter of the pieces of candy to be dispensed. Further, the axial distance between each spiral must be greater than the diameter of the candy to be dispensed. The spiral need not extend to the inner surface of the outer housing but must extend radially a distance so that the pieces of candy will not drop between the spiral and an inner surface of the outer housing.

Each end cap is provided with an aperture 24 in a door 26 through which candy pieces 28 can pass in order to allow the candy pieces to race along the spiral candy track to exit through an aperture in a lower door. The upper and lower housings are shown with J-shaped protrusions 30 which fit into female notches 32 in the end caps so that the two housings can be secured together in axial alignment as shown in FIG. 4. With the two housings secured end-to-end as shown in FIG. 4, the pieces of candy in the upper housing will pass through the aperture in the lower end of the upper housing and through an aligned aperture in the upper end of the lower housing. The candy pieces will then race along the spiral in the lower housing and out of the aperture in the lower end cap of the lower housing. The door in the end caps may be provided with spring-loaded slide pieces which can close the aperture in the ends so that the candy can collect in the semi-spherical end reservoir for reversing the position of the housings so that the candy will race through the two housing sections in the opposite direction. Thus, the racing can be through the housings in one or two directions.

FIG. 2 illustrates two axially aligned housings 10 in which is secured an axial rod 34. Spaced parallel shelves 36 are secured to the rod 34. The alternate shelves are extended substantially to the inner wall surface of the housing and the opposite ends of the shelves are spaced from the inner surface of the wall a distance which will permit pieces of candy to pass by the end of the shelf. The upper and lower ends of the housing are the same as the semispherical reservoir and end caps as shown in FIG. 1. Further, the two housing sections can be secured together by hooks and slots such as set forth in FIG. 1.

FIG. 3 is a combination of one section of the housing shown in FIG. 1 including the inner housing and spiral candy tracks as shown in FIG. 1. The other housing section is the same as one of the housing sections shown in FIG. 2. The candy tracks in this housing are the same as the candy tracks shown in FIG. 2. The ends of each of the housings are provided with the male J-shaped connectors and the female slots in the other ends of the housings.

FIG. 4 illustrates two axially aligned housings secured together with the J-connectors fitted into the female slots. As shown, the lower housing 10 and race track are the same as shown for FIG. 1. The upper housing shown in FIG. 4 has an axially extending rod to which space parallel shelves are secured. The shelves are provided with an aperture near an inner wall of the housing. The aperture must be sufficiently large to permit a piece of candy to pass to the next adjacent shelf. The end caps are the same as those shown for FIGS. 1-3.

In use of each of the candy racers set forth in FIGS. 1-4, candy can be directed through the aperture in the upper end cap. Then the candy will race down via the candy track shown for each of the upper housings. With the lower housing connected to the upper housing as shown in FIG. 4, the candy will fall through the aperture in the lower end cap of the upper housing on through the upper end cap of the lower housing and on along the race tracks to the bottom semispherical reservoir. The racing housings can then be flipped so that the lower housing becomes the upper housing; then the candy pieces will follow the race tracks as previously set forth.

Throughout the specification applicants have set forth pieces of candy. Pieces of candy signifies any type of edible or non-edible product. For instance, a marble or multiple marbles could be used as the racing item. Thus the housings and race track spaces must be sufficiently large to accommodate the size of the marbles.

For amusement of one or more children, any product that can pass through the parts of the housing and race track can be used. For enjoyment and for eating the product, of course, an edible product such as candy, gum balls or pieces of gum, jelly beans, or any other substance can be used.

The foregoing relates to preferred exemplary embodiments of the invention, it being understood that other variants and embodiments thereof are possible within the spirit and scope of the invention, the latter being defined by the appended claims.

We claim:

1. A product racer dispenser which comprises:
an elongated housing formed by upper and lower identical housing sections having upper and lower ends, each end of each housing section including a semispherical end portion,
a product race track along a length of each of said upper and lower housing sections, said race track having spaced product diversion parts within said housing which have a spacing suitable for passage of a piece of product to a next diversion part and on to an outlet, and
an upper and lower end cap covering each of an upper and lower semispherical reservoir,
said upper and lower end caps having a receptacle therein through which pieces of said products will pass to the race track.

2. A product racer dispenser as set forth in claim 1, in which one end of each of said upper and lower housings include a means for securing said one end to another end of each of said upper and lower housings to secure said upper housing to said lower housing.

3. A product racer dispenser as set forth in claim 1, in which
each of said upper and lower housing sections include an inner housing, and a spiral race track surrounding said inner housing of each of said upper and lower housing sections.

4. A product racer dispenser as set forth in claim 2, in which
each of said upper and lower housing sections include an inner housing, and a spiral race track surrounding said inner housing of each of said upper and lower housing sections.

5. A product racer dispenser as set forth in claim 1, in which
each of said upper and lower housings include an axial rod that extends from said upper semispherical upper reservoir to said lower semispherical reservoir, and
equally spaced diversion plates that are connected to said axial rod.

6. A product racer dispenser as set forth in claim 2, in which
each of said upper and lower housings include an axial rod that extends from said upper semispherical upper reservoir to said lower semispherical reservoir, and
equally spaced diversion plates that are connected to said axial rod.

7. A product racer dispenser as set forth in claim 1, in which
said upper housing includes an elongated inner housing spaced from said outer housing,
a spiral race track surrounding said inner housing for forming a race trace for said product,
a lower housing secured to said upper housing,
said lower housing including an axial rod extending between said upper and lower semispherical ends, and
equally spaced product diversion plates secured to said axial rod over an entire length thereof for forming a race track for said product.

8. A product racer dispenser as set forth in claim 2, in which
said upper housing includes an elongated inner housing spaced from said outer housing,
a spiral race track surrounding said inner housing for forming a race trace for said product,
a lower housing secured to said upper housing,
said lower housing including an axial rod extending between said upper and lower semispherical ends, and
equally spaced product diversion plates secured to said axial rod over an entire length thereof for forming a race track for said product.

9. A product racer dispenser as set forth in claim 1, in which
said upper housing includes an axial rod that extends from the upper semispherical reservoir to said lower semispherical reservoir,
equally spaced product diversion plates secured to said axial rod along a length thereof,
each of said diversion plates having an aperture therein for passing a product,
a lower housing secured to said upper housing in axial alignment therewith,
said lower housing including an inner housing spaced from an inner surface of said lower housing, and
a spiral race track surrounding said inner housing in said lower housing from an upper end of said lower housing to a bottom end of the lower housing for directing a product along a length of the lower housing.

10. A product racer dispenser as set forth in claim 2, in which
said upper housing includes an axial rod that extends from the upper semispherical reservoir to said lower semispherical reservoir,
equally spaced product diversion plates secured to said axial rod along a length thereof,
each of said diversion plates having an aperture therein for passing a product,
a lower housing secured to said upper housing in axial alignment therewith,
said lower housing including an inner housing spaced from an inner surface of said lower housing, and
a spiral race track surrounding said inner housing in said lower housing from an upper end of said lower housing to a bottom end of the lower housing for directing a product along a length of the lower housing.
